(19) United States
(12) Patent Application Publication
(10) Pub. No.: US 2014/0289491 A1
(43) Pub. Date: Sep. 25, 2014

(54) DATA PROCESSING DEVICE

(71) Applicants: FUJITSU SEMICONDUCTOR LIMITED, Yokohama-shi (JP); FUJITSU LIMITED, Kawasaki-shi (JP)

(72) Inventors: Kazuo Horio, Yokohama (JP); Hiroshi Hatano, Kawasaki (JP)

(73) Assignees: FUJITSU SEMICONDUCTOR LIMITED, Yokohama-shi (JP); FUJITSU LIMITED, Kawasaki-shi (JP)

(21) Appl. No.: 14/180,758

(22) Filed: Feb. 14, 2014

(30) Foreign Application Priority Data
Mar. 19, 2013 (JP) 2013-056569

(51) Int. Cl. G06F 3/06

(52) U.S. Cl. CPC G06F 3/0652; G06F 3/0608; G06F 3/0673
USPC 711/166

(57) ABSTRACT

A data processing device has: a shift circuit that makes data with a certain bit length to be input therein for each cycle, and shifts the data to delete first invalid data in the data; and a gate circuit that cuts, when data as a result of combining pieces of the shifted data for each cycle has the certain bit length or more, first data with the certain bit length to output the data to an outside.

### CROSS-REFERENCE TO RELATED APPLICATION

This application is based upon and claims the benefit of priority of the prior Japanese Patent Application No. 2013-056569, filed on Mar. 19, 2013, the entire contents of which are incorporated herein by reference.

### FIELD

The embodiments discussed herein are directed to a data processing device.

### BACKGROUND

There is known a bridge for a computer system including a first bus and a second bus, the bridge being disposed between the first bus and the second bus (refer to Patent Document 1, for example). A shifter has an input connected for receiving a byte from one of the first bus and the second bus, and an output for performing, on a shifted byte, selectable shift regarding the received byte. An accumulator has an input connected for receiving an output of the shifter, and performs selective accumulation of shifted byte. The accumulator has an output for supplying a re-aligned byte to be sent from one of the first bus and the second bus to the other.

There is known a method of reading unaligned data in a processor (refer to Patent Document 2, for example). The unaligned data is stored in one memory, and the memory is divided into a plurality of m-bit words by word boundaries. The unaligned data is divided by word boundaries into a first part, a second part and a third part. This method includes a start capture step, an intermediate capture step, a first shift step, an end capture step, and a second shift step. In the start capture step, a first instruction is executed to capture a first word from a part of the memory including the first part. In the intermediate capture step, a second instruction is executed to capture a second word from a part of the memory including the second part. In the first shift step, the first word and the second word are connected in series, and the resultant is shifted to a first position. In the end capture step, a third instruction is executed to capture a third word from a part of the memory including the third part. In the second shift step, the second word and the third word are connected in series, and the resultant is shifted to the first position.
Patent Document 1: Japanese Laid-open Patent Publication No. 2000-267989
Patent Document 2: Japanese Laid-open Patent Publication No. 2005-267209

Among memories, there is one that reads data with a certain bit length for each cycle and outputs the data. It is not possible for such a memory to cut and output only valid data, so that the memory outputs data with the certain bit length including the valid data and/or invalid data. When such a memory is employed, a calculation unit is needed to perform calculation by ignoring the invalid data and using only the valid data out of the data output from the memory. When there is the invalid data, a waiting time is generated in the calculation of the calculation unit, which is a problem.

### SUMMARY

A data processing device has: a shift circuit that makes data with a certain bit length to be input therein for each cycle, and shifts the data to delete first invalid data in the data; and a gate circuit that cuts, when data as a result of combining pieces of the shifted data for each cycle has the certain bit length or more, first data with the certain bit length to output the data to an outside.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a configuration example of a data processing device according to the present embodiment;

FIG. 2 is a diagram illustrating an example of calculation performed by a calculation unit in FIG. 1;

FIG. 3 is a diagram illustrating a configuration example of a memory in FIG. 1;

FIG. 4 is a diagram illustrating an example of data input by a data processing circuit in FIG. 1;

FIG. 5 is a diagram illustrating another example of processing performed by the data processing circuit in FIG. 1;

FIG. 6 is a diagram illustrating a data stream of valid data as a result of deleting invalid data;

FIG. 7 is a diagram illustrating a configuration example of the data processing circuit in FIG. 1;

FIG. 8 is a diagram illustrating a configuration example of a shift selection circuit in FIG. 7;

FIG. 9A and FIG. 9B are diagrams illustrating examples of data;

FIG. 10 is a diagram illustrating an example of processing of the data processing circuit in FIG. 7 in a first cycle;

FIG. 11 is a diagram illustrating an example of processing of the shift selection circuit in FIG. 8 in the first cycle;

FIG. 12 is a diagram illustrating an example of processing of the data processing circuit in FIG. 7 in a second cycle;

FIG. 13 is a diagram illustrating an example of processing of the shift selection circuit in FIG. 8 in the second cycle;

FIG. 14 is a diagram illustrating an example of processing of the data processing circuit in FIG. 7 in a third cycle;

FIG. 15 is a diagram illustrating an example of processing of the shift selection circuit in FIG. 8 in the third cycle;

FIG. 16 is a diagram illustrating an example of processing of the data processing circuit in FIG. 7 in a fourth cycle;

FIG. 17 is a diagram illustrating an example of processing of the shift selection circuit in FIG. 8 in the fourth cycle;

FIG. 18 is a diagram illustrating an example of processing of the data processing circuit in FIG. 7 in a fifth cycle; and

FIG. 19 is a diagram illustrating an example of processing of the data processing circuit in FIG. 7 in a sixth cycle.

### DESCRIPTION OF EMBODIMENTS

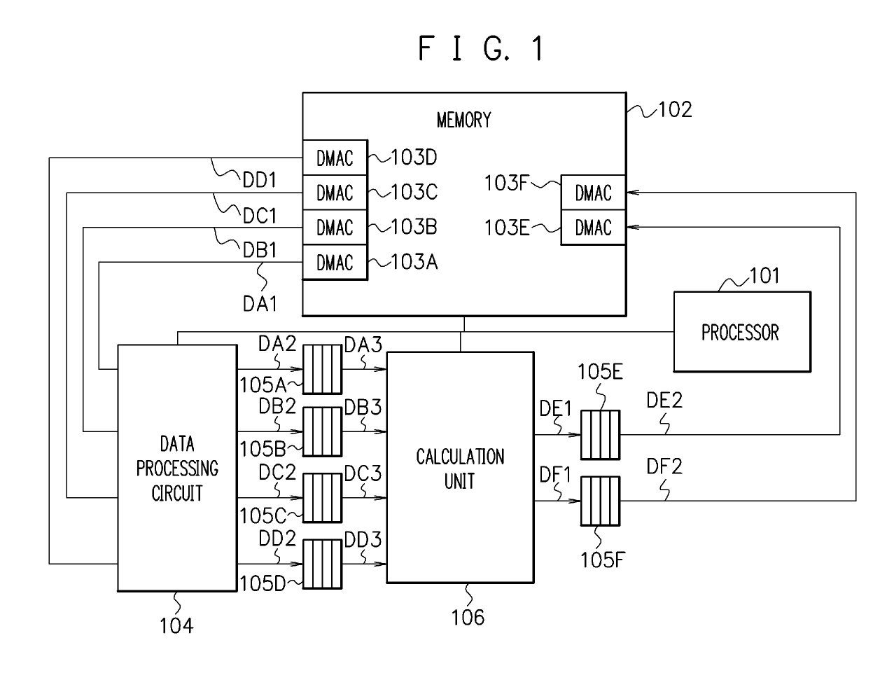

FIG. 1 is a diagram illustrating a configuration example of a data processing device according to the present embodiment. The data processing device has a processor 101, a memory 102, a data processing circuit 104, first-in-first-out (FIFO) circuits 105A to 105F and a calculation unit 106. The memory 102 has direct memory access controllers (DMACs) 103A to 103F. The processor 101 controls the memory 102, the data processing circuit 104 and the calculation unit 106.

When a read instruction including a read start address and a read data length is input from the processor 101 into each of the direct memory access controllers 103A to 103D, the direct memory access controllers 103A to 103D read data corresponding to the read instruction from the memory 102, and output pieces of data DA1 to DD1 to the data processing circuit 104. The data processing circuit 104 makes the pieces of data DA1 to DD1 to be input therein, deletes invalid data in the pieces of data DA1 to DD1, and outputs pieces of valid data DA2 to DD2. The respective first-in-first-out circuits 105A to 105D buffer the pieces of valid data DA2 to DD2 in a first-in-first-out order, and output pieces of data DA3 to DD3. The calculation unit 106 performs calculation by using all of or a part of the pieces of data DA3 to DD3, and outputs data DE1 and/or DF1. The respective first-in-first-out circuits 105E and 105F buffer the pieces of data DE1 and DF1 in a first-in-first-out order, and output pieces of data DE2 and DF2. When a write instruction including a write start address and a write data length is input from the processor 101 into each of the direct memory access controllers 103E and 103F, the direct memory access controllers 103E and 103F write the pieces of data DE2 and DF2 into an address of the memory 102 corresponding to the write instruction.

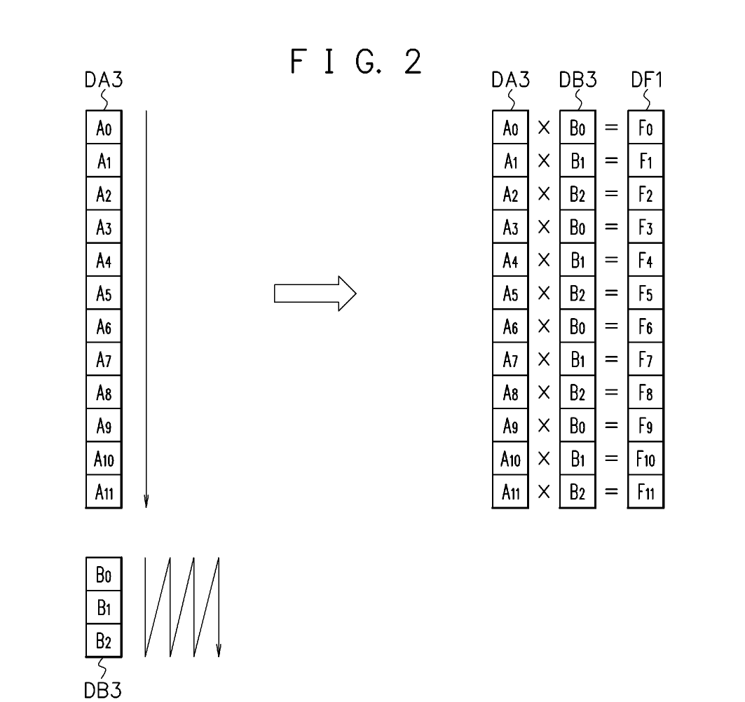

FIG. 2 is a diagram illustrating an example of calculation performed by the calculation unit 106 in FIG. 1. The calculation unit 106 makes pieces of data DA3 and DB3 to be input therein, and performs calculation represented by the following equations to output the data DF1.

A0×B0=F0

A1×B1=F1

A2×B2=F2

A3×B0=F3

A4×B1=F4

A5×B2=F5

A6×B0=F6

A7×B1=F7

A8×B2=F8

A9×B0=F9

A10×B1=F10

A11×B2=F11

The data DA3 has pieces of data A0 to A11. The data DB3 has four sets of data B0 to B2. The data DF1 has pieces of data F0 to F11. In this case, the direct memory access controller 103A reads the twelve pieces of data A0 to A11 once as the data DA1. On the contrary, the direct memory access controller 103B repeatedly reads three pieces of data B0 to B2 four times as the data DB1.

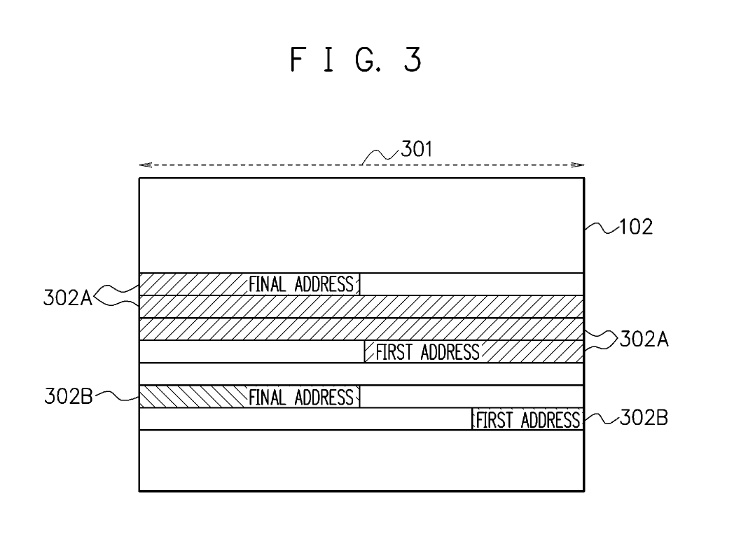

FIG. 3 is a diagram illustrating a configuration example of the memory 102 in FIG. 1. The memory 102 performs reading and writing of data in a unit of memory line 301 with a certain bit length (512 bits, for example) for each cycle. The memory 102 stores 16-bit data in each address, for example.

A data stream 302A is stored on four memory lines, for example, and a first address and a final address thereof are positioned in addresses which are not boundaries of the memory lines. When the read instruction including the read start address and the read data length is input from the processor 101 into the direct memory access controller 103A, the direct memory access controller 103A reads, from the memory 102, data of four memory lines (4×512 bits) including the data stream 302A corresponding to the read instruction, and outputs the data DA1 to the data processing circuit 104.

A data stream 302B is stored on two memory lines, for example, and a first address and a final address thereof are positioned in addresses which are not boundaries of the memory lines. When the read instruction including the read start address and the read data length is input from the processor 101 into the direct memory access controller 103B, the direct memory access controller 103B reads, from the memory 102, data of two memory lines (2×512 bits) including the data stream 302B corresponding to the read instruction, and outputs the data DB1 to the data processing circuit 104.

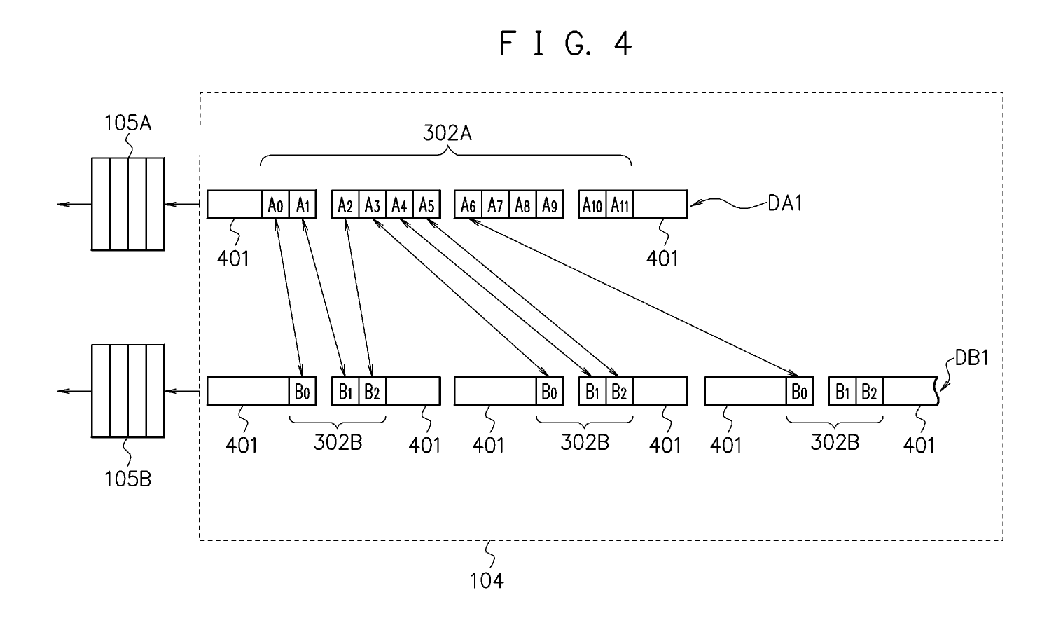

FIG. 4 is a diagram illustrating an example of the pieces of data DA1 and DB1 input by the data processing circuit 104 in FIG. 1. The data DA1 is configured by the data of four memory lines including the data stream 302A as illustrated in FIG. 3, and the data stream 302A has the twelve pieces of data A0 to A11 as illustrated in FIG. 2. The data DA1 has the data stream 302A being valid data, and invalid data 401. The data processing circuit 104 deletes the invalid data 401, and outputs the data stream 302A being the valid data to the first-in-first-out circuit 105A.

The data DB1 is obtained by repeatedly reading the data of two memory lines including the data stream 302B four times from the memory 102, as illustrated in FIG. 2 and FIG. 3. Note that in FIG. 4, a fourth data stream 302B is omitted. Each data stream 302B is configured by three pieces of data B0 to B2. The data DB1 has the data stream 302B being valid data, and invalid data 401. The data processing circuit 104 deletes the invalid data 401, combines three data streams 302B being the valid data and outputs the resultant to the first-in-first-out circuit 105B.

Accordingly, the calculation unit 106 can perform the calculation illustrated in FIG. 2, by making the twelve pieces of data A0 to A11 and the twelve pieces of data B0 to B2, B0 to B2, B0 to B2, and B0 to B2 correspond to each other.

As described above, the memory 102 reads the data in the unit of memory line 301 with the certain bit length for each cycle, and outputs the data. It is not possible for the memory 102 to cut and output only the valid data, so that the memory 102 outputs the data with the certain bit length including the valid data and the invalid data 401. When there is the invalid data 401, the calculation unit 106 is needed to perform calculation by ignoring the invalid data 401 and using only the valid data out of the data output from the memory 102, and accordingly, there exists a problem that a waiting time is generated in the calculation of the calculation unit 106.

In the present embodiment, the data processing circuit 104 can delete the invalid data 401 in the data with the certain bit length to generate the stream of valid data. Accordingly, it is possible to eliminate a loss caused by the waiting time in the calculation using the data.

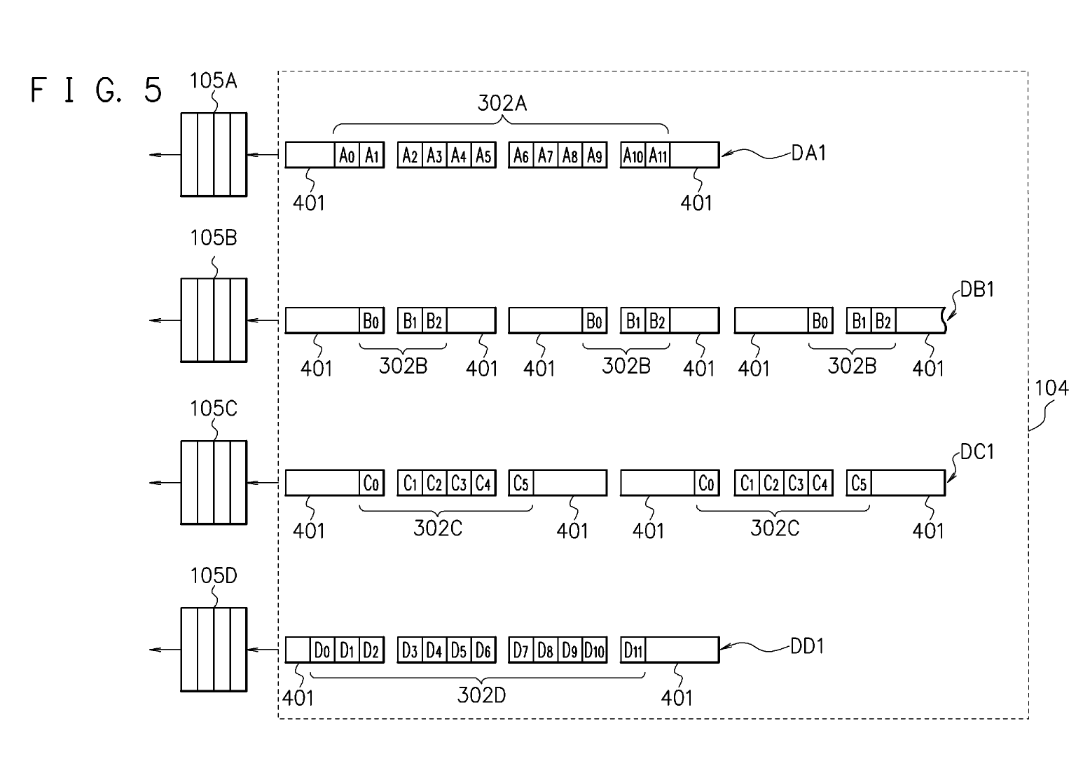

FIG. 5 is a diagram illustrating another example of processing of the data processing circuit 104 in FIG. 1. Processing regarding the pieces of data DA1 and DB1 is the same as the processing in FIG. 4.

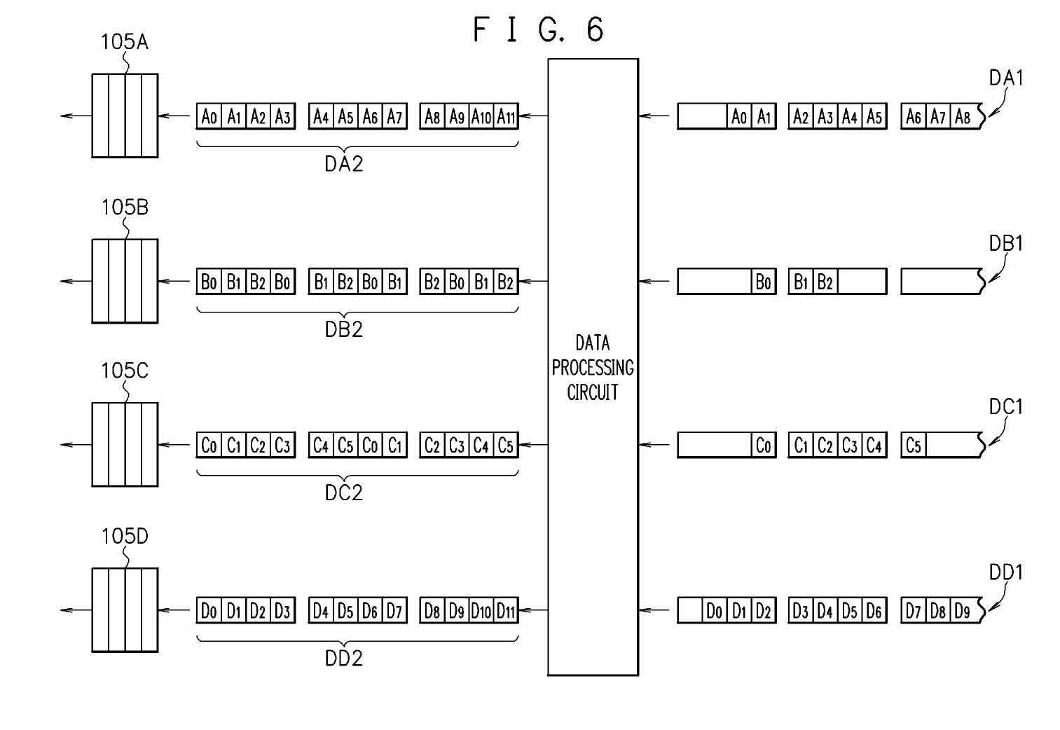

The data processing circuit 104 makes the data DA1 to be input therein, deletes the invalid data 401, and outputs the data DA2 configured by the data stream 302A being the valid data to the first-in-first-out circuit 105A, as illustrated in FIG. 6.

Further, the data processing circuit 104 makes the data DB1 to be input therein, deletes the invalid data 401, and outputs the data DB2 as a result of combining four data streams 302B being the valid data to the first-in-first-out circuit 105B, as illustrated in FIG. 6.

Data DC1 is obtained by repeatedly reading data of three memory lines including a data stream 302C twice from the memory 102. Each data stream 302C is configured by six pieces of data C0 to C5. The data DC1 has the data stream 302C being valid data, and invalid data 401. The data processing circuit 104 makes the data DC1 to be input therein, deletes the invalid data 401, and outputs data DC2 as a result of combining two data streams 302C being the valid data to the first-in-first-out circuit 105C, as illustrated in FIG. 6.

The data DD1 is obtained by reading data of four memory lines including a data stream 302D. The data stream 302D is configured by twelve pieces of data D0 to D11. The data DD1 has the data stream 302D being valid data, and invalid data 401. The data processing circuit 104 makes the data DD1 to be input therein, deletes the invalid data 401, and outputs the data DD2 configured by the data stream 302D being the valid data to the first-in-first-out circuit 105D, as illustrated in FIG. 6.

In this case, the calculation unit 106 in FIG. 1 makes the pieces of data DA3 to DD3 to be input therein, and performs calculation represented by the following equations, for example, to output the data DF1.

A0×B0+C0+D0=F0

A1×B1+C1+D1=F1

A2×B2+C2+D2=F2

A3×B0+C3+D3=F3

A4×B1+C4+D4=F4

A5×B2+C5+D5=F5

A6×B0+C0+D6=F6

A7×B1+C1+D7=F7

A8×B2+C2+D8=F8

A9×B0+C3+D9=F9

A10×B1+C4+D10=F10

A11×B2+C5+D11=F11

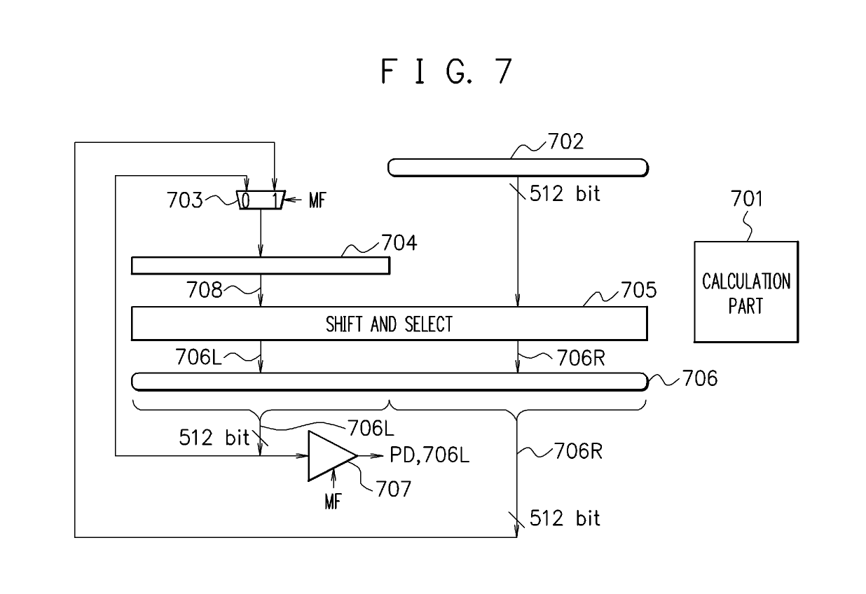

FIG. 7 is a diagram illustrating a configuration example of the data processing circuit 104 in FIG. 1. The data processing circuit 104 has a calculation part 701, a selector 703, a buffer 704, a shift selection circuit 705 and a gate circuit 707. Regarding the circuit in FIG. 7, four of the circuits are provided by corresponding to the four pieces of data DA1 to DD1. Data 702 is, for example, the data DA1, and is data with a certain bit length of 512 bits. The 512-bit data 702 is input from the memory 102 for each cycle. The selector 703 selects 512-bit data 706L when a control signal MF is “0”, and selects 512-bit data 706R when the control signal MF is “1”. The buffer 704 buffers the 512-bit data selected by the selector 703, and outputs 512-bit data 708. The shift selection circuit 705 makes the pieces of 512-bit data 702 and 708 to be input therein, and outputs 2×512-bit data 706 after being subjected to shift and selection processing. The data 706 has the first-half 512-bit data 706L and the latter-half 512-bit data 706R. When the control signal MF becomes “1”, the gate circuit 707 outputs the 512-bit data 706L and a write request signal PD to the first-in-first-out circuits 105A to 105D corresponding to the write request signal PD. Accordingly, the 512-bit data 706L is written into the first-in-first-out circuits 105A to 105D corresponding to the write request signal PD.

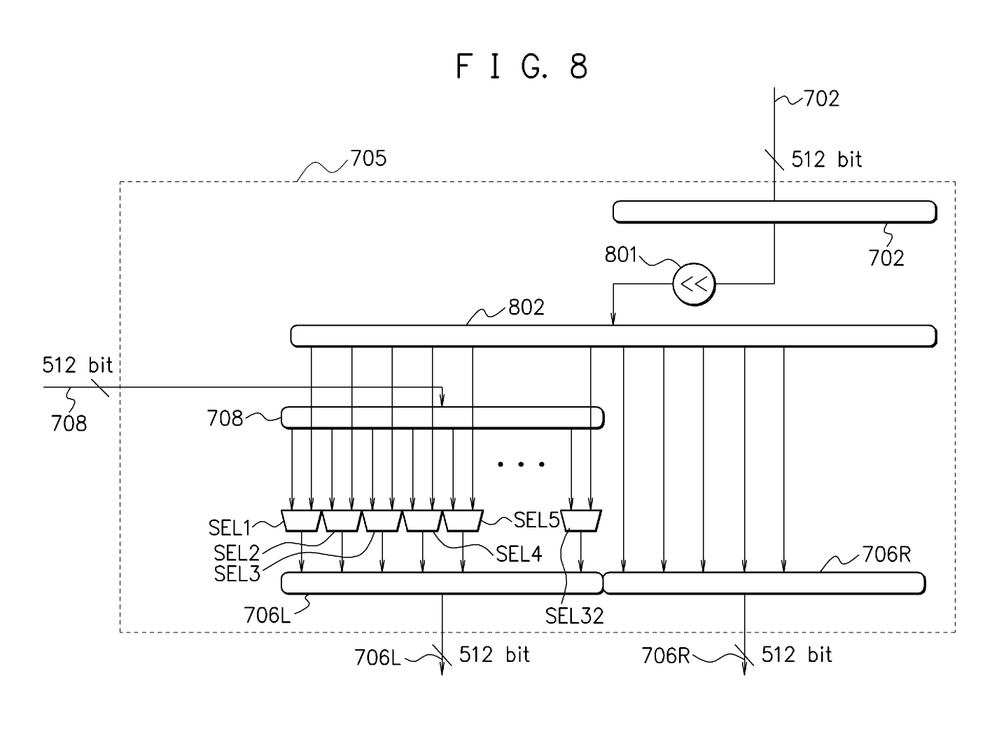

FIG. 8 is a diagram illustrating a configuration example of the shift selection circuit 705 in FIG. 7. The shift selection circuit 705 has a shift circuit 801 and 32 pieces of selectors SEL1 to SEL32. The shift circuit 801 makes the data 702 with the certain bit length to be input therein for each cycle, shifts the data 702 in the left direction to delete first invalid data 401 in the data 702, and outputs 2×512-bit data 802. The 32 pieces of selectors SEL1 to SEL32 select the first-half 512-bit data in the data 802 or the 512-bit data 708 in a unit of 16 bits, and output the 512-bit data 706L. Each address of the memory 102 stores 16-bit data, so that each of the selectors SEL1 to SEL32 selects and outputs the 16-bit data. Concretely, the selectors SEL1 to SEL32 select the data 708 regarding a bit in a region of valid data in the data 708, and select the data 802 regarding a bit in a region of invalid data in the data 708. The latter-half 512-bit data in the data 802 is output as the 512-bit data 706R.

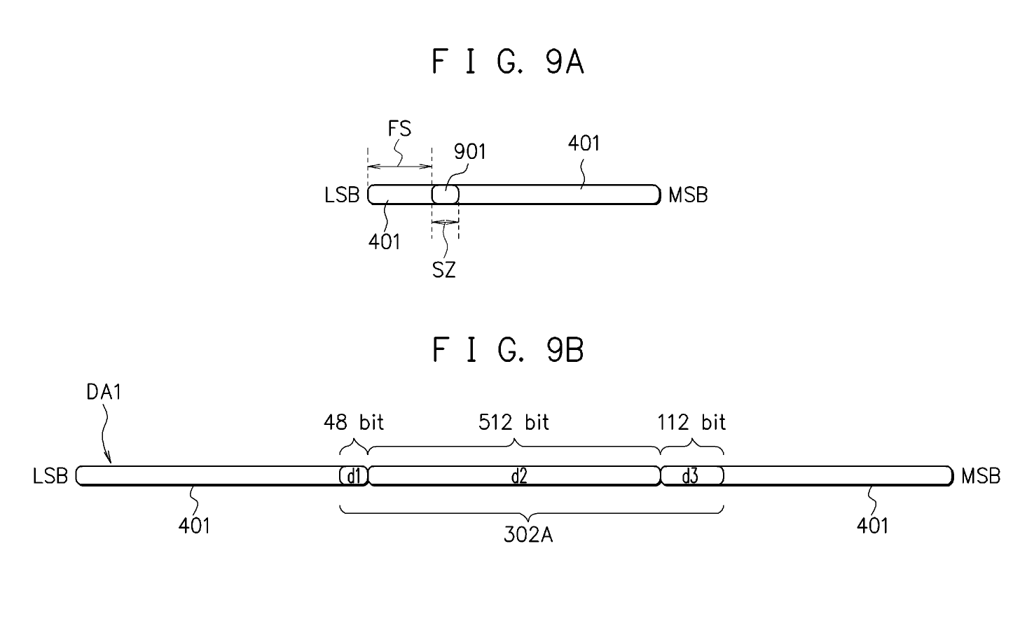

FIG. 9A is a diagram illustrating an example of the 512-bit data 702 in FIG. 7. The 512-bit data 702 has a least significant bit LSB, a most significant bit MSB, valid data 901 and invalid data 401. A valid data length SZ corresponds to a bit length of the valid data 901. A valid data offset FS corresponds to a bit length from the least significant bit LSB to a first address of the valid data 901.

FIG. 9B is a diagram illustrating an example of the data DA1. The data DA1 is data of three memory lines including the valid data stream 302A and the invalid data 401. The valid data steam 302A has 48-bit valid data d1, 512-bit valid data d2 and 112-bit valid data d3. The first memory line stores the invalid data 401 and the 48-bit valid data d1. The second memory line stores the 512-bit valid data d2. The third memory line stores the 112-bit valid data d3 and the invalid data 401. Hereinafter, an example of processing in which the data DA1 in FIG. 9B is continuously read twice from the memory 102, will be described.

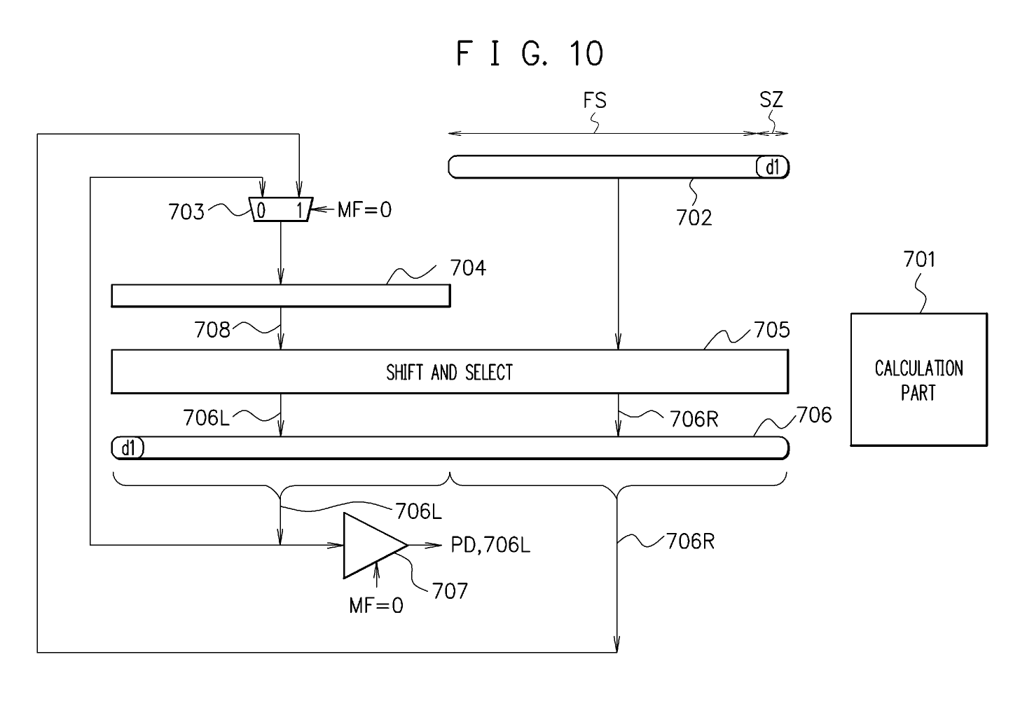

FIG. 10 is a diagram illustrating an example of processing of the data processing circuit 104 in FIG. 7 in a first cycle. In the first to third cycles, the data DA1 in FIG. 9B for the first time is processed. In the first cycle, data of the first memory line in FIG. 9B is input as the 512-bit data 702. The 512-bit data 702 has the valid data d1, the valid data offset FS of 464 (=512-48) bits, and the valid data length SZ of 48 bits. The calculation part 701 calculates, based on information from the processor 101 or the direct memory access controllers 103A to 103D in FIG. 1, the valid data offset FS and the valid data length SZ.

Further, the calculation part 701 calculates a shift amount SH through the following equation. Here, at an initial time, a valid data length BS of the buffer 704 in the next cycle is 0 bit.

$$\begin{matrix}SH = FS - BS + 512 \\ = 464 - 0 + 512 \\ = 976 bits\end{matrix}$$

Further, the calculation part 701 calculates a valid data length BSt in the next cycle through the following equation.

$$\begin{matrix}BSt = SZ + BS \\ = 48 + 0 \\ = 48 bits\end{matrix}$$

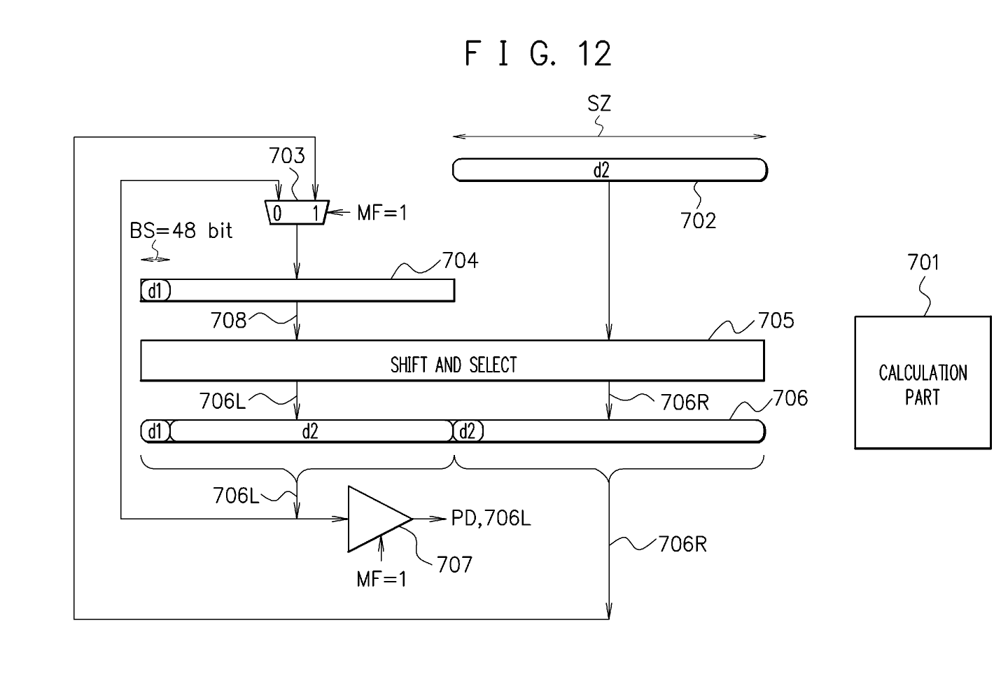

Since the valid data length BSt in the next cycle is less than 512 bits, the calculation part 701 sets the valid data length BS of the buffer 704 in the next cycle (FIG. 12) through the following equation.

$$\begin{matrix}BS = BSt \\ = 48 bits\end{matrix}$$

Further, since the valid data length BSt in the next cycle is less than 512 bits, the calculation part 701 sets the control signal MF to “0”.

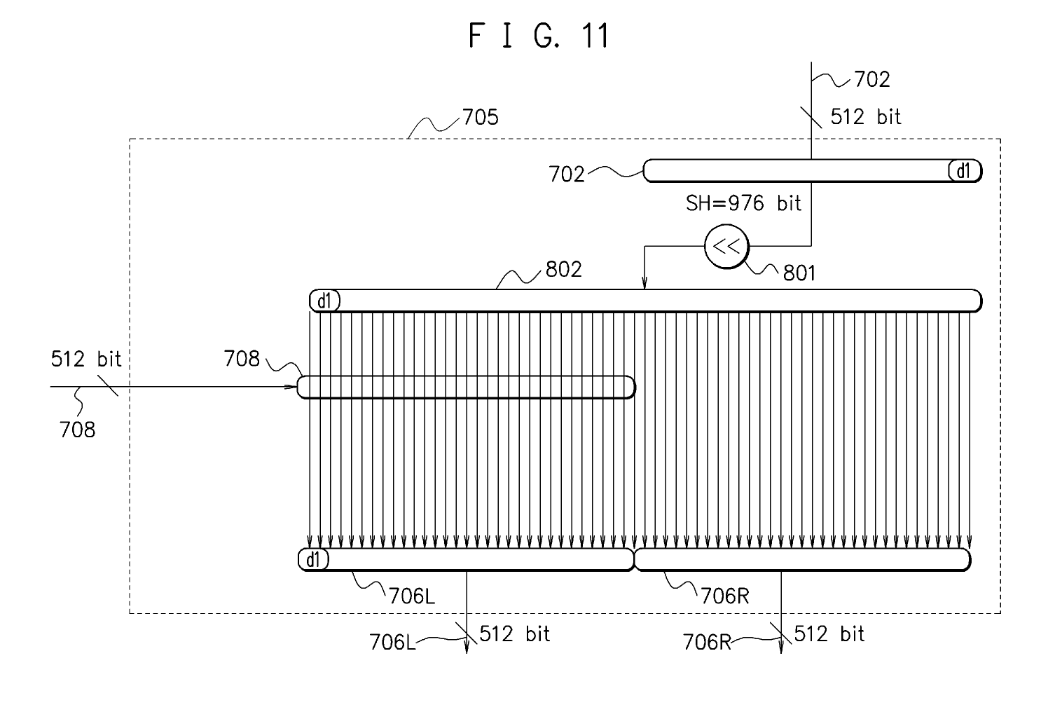

Next, an operation of the shift selection circuit 705 will be described while referring to FIG. 11. FIG. 11 is a diagram illustrating an example of processing of the shift selection circuit 705 in FIG. 8 in the first cycle. In the first cycle, the shift circuit 801 shifts the 512-bit data 702 in the left direction by the shift amount SH (=976 bits), and outputs the 2×512-bit data 802. The 48-bit valid data d1 is positioned at the first position of the data 802.

In FIG. 8, the n-th selector SELn selects the data 802 when the following equation is satisfied, selects the data 708 when the following equation is not satisfied, and outputs the selected data. Here, BS indicates a current valid data length of the buffer 704 in FIG. 10, and the valid data length BS is 0 bit.

n>BS/16

n>0/16

n>0

In FIG. 11, all of the selectors SEL1 to SEL32 select the data 802, and output the 512-bit data 706L. As a result of this, the first-half 512-bit data 706L becomes the same as 512-bit data being first-half data of the 2×512-bit data 802. The latter-half 512-bit data 706R becomes the same as 512-bit data being latter-half data of the 2×512-bit data 802. Specifically, the 2×512-bit data 706 becomes the same as the 2×512-bit data 802.

Next, in FIG. 10, since the control signal MF is “0”, the gate circuit 707 does not output the 512-bit data 706L and the write request signal PD. Further, since the control signal MF is “0”, the selector 703 selects the data 706L, resulting in that the 512-bit data 706L in FIG. 10 is written into the buffer 704, as illustrated in FIG. 12.

FIG. 12 is a diagram illustrating an example of processing of the data processing circuit 104 in FIG. 7 in a second cycle. In the second cycle, data of the second memory line in FIG. 9B is input as the 512-bit data 702. The 512-bit data 702 has the valid data d2, the valid data offset FS of 0 bit, and the valid data length SZ of 512 bits.

Further, the calculation part 701 calculates the shift amount SH through the following equation.

$$\begin{matrix}SH = FS - BS + 512 \\ = 0 - 48 + 512 \\ = 464 bits\end{matrix}$$

Further, the calculation part 701 calculates the valid data length BSt in the next cycle through the following equation.

$$\begin{matrix}BSt = SZ + BS \\ = 512 + 48 \\ = 560 bits\end{matrix}$$

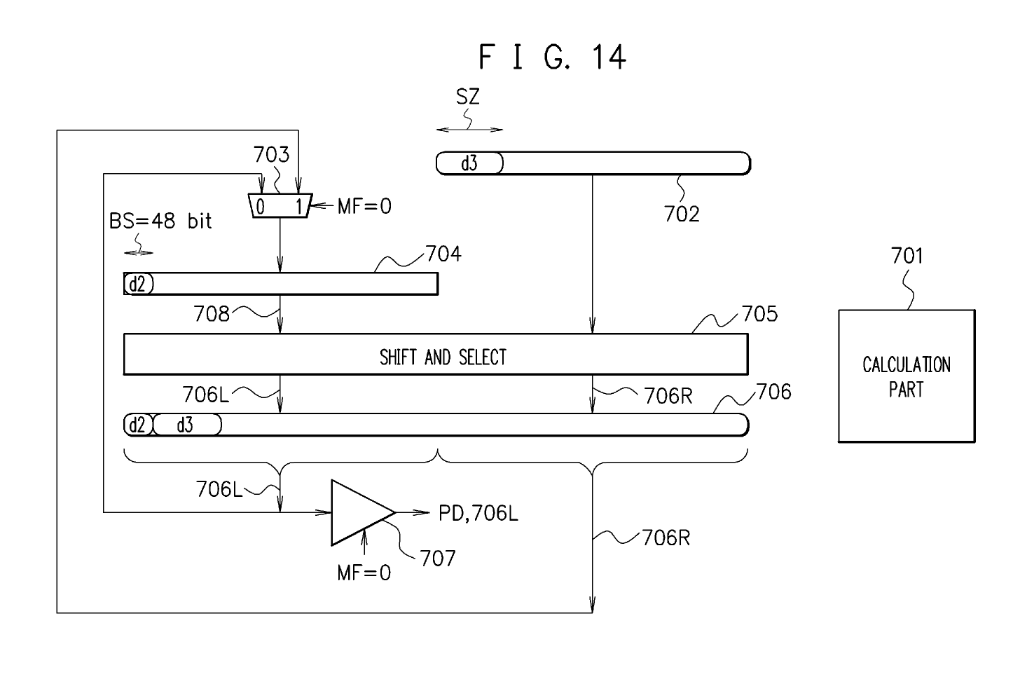

Since the valid data length BSt in the next cycle is 512 bits or more, the calculation part 701 sets the valid data length BS of the buffer 704 in the next cycle (FIG. 14) through the following equation.

$$\begin{matrix}BS = BSt - 512 \\ = 560 - 512 \\ = 48 bits\end{matrix}$$

Further, since the valid data length BSt in the next cycle is 512 bits or more, the calculation part 701 sets the control signal MF to “1”.

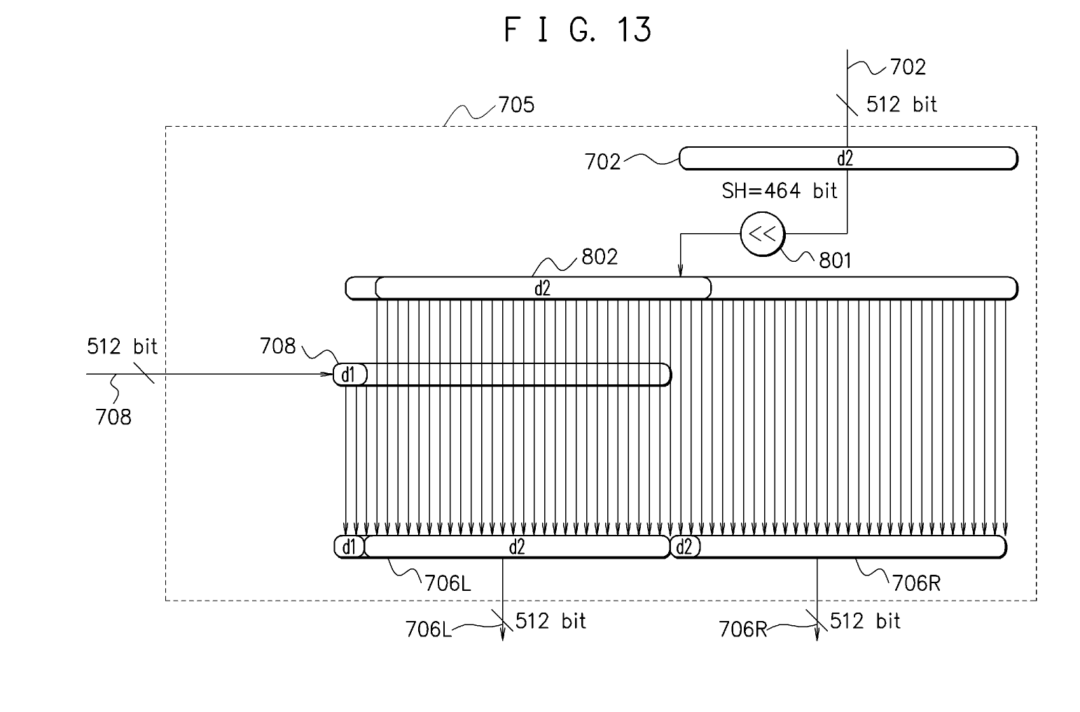

Next, an operation of the shift selection circuit 705 will be described while referring to FIG. 13. FIG. 13 is a diagram illustrating an example of processing of the shift selection circuit 705 in FIG. 8 in the second cycle. In the second cycle, the shift circuit 801 shifts the 512-bit data 702 in the left direction by the shift amount SH (=464 bits), and outputs the 2×512-bit data 802.

In FIG. 8, the n-th selector SELn selects the data 802 when the following equation is satisfied, selects the data 708 when the following equation is not satisfied, and outputs the selected data. Here, BS indicates a current valid data length of the buffer 704 in FIG. 12, and the valid data length BS is 48 bits.

n>BS/16

n>48/16

n>3

In FIG. 13, the selectors SEL1 to SEL3 select the data 708, the selectors SEL4 to SEL32 select the data 802, and the 512-bit data 706L is output. As a result of this, the first-half 512-bit data 706L has the 48-bit valid data d1 and the first (512−48)-bit valid data d2. Further, the latter-half 512-bit data 706R becomes the same as latter-half 512-bit data of the 2×512-bit data 802, and has the 48-bit valid data d2 at the final portion.

Next, in FIG. 12, since the control signal MF is “1”, the gate circuit 707 outputs the 512-bit data 706L and the write request signal PD to the first-in-first-out circuits 105A to 105D in FIG. 1 corresponding to the write request signal PD. Further, since the control signal MF is “1”, the selector 703 selects the data 706R, resulting in that the 512-bit data 706R in FIG. 12 is written into the buffer 704, as illustrated in FIG. 14.

FIG. 14 is a diagram illustrating an example of processing of the data processing circuit 104 in FIG. 7 in a third cycle. In the third cycle, data of the third memory line in FIG. 9B is input as the 512-bit data 702. The 512-bit data 702 has the valid data d3, the valid data offset FS of 0 bit, and the valid data length SZ of 112 bits.

Further, the calculation part 701 calculates the shift amount SH through the following equation.

$$\begin{matrix}SH = FS - BS + 512 \\ = 0 - 48 + 512 \\ = 464 bits\end{matrix}$$

Further, the calculation part 701 calculates the valid data length BSt in the next cycle through the following equation.

$$\begin{matrix}BSt = SZ + BS \\ = 112 + 48 \\ = 160 bits\end{matrix}$$

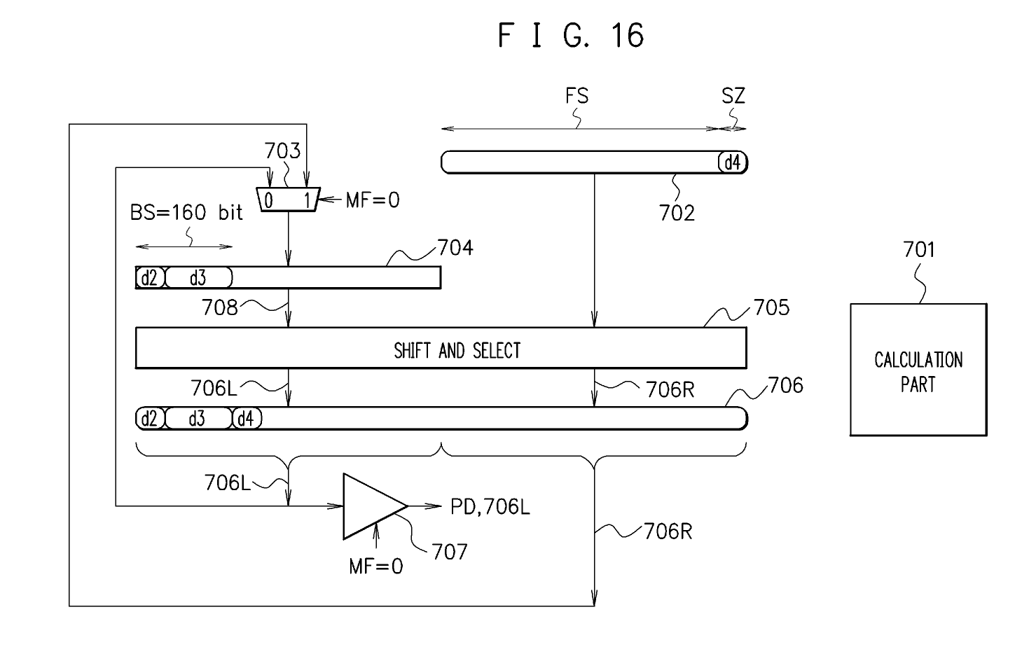

Since the valid data length BSt in the next cycle is less than 512 bits, the calculation part 701 sets the valid data length BS of the buffer 704 in the next cycle (FIG. 16) through the following equation.

$$\begin{matrix}BS = BSt \\ = 160 bits\end{matrix}$$

Further, since the valid data length BSt in the next cycle is less than 512 bits, the calculation part 701 sets the control signal MF to “0”.

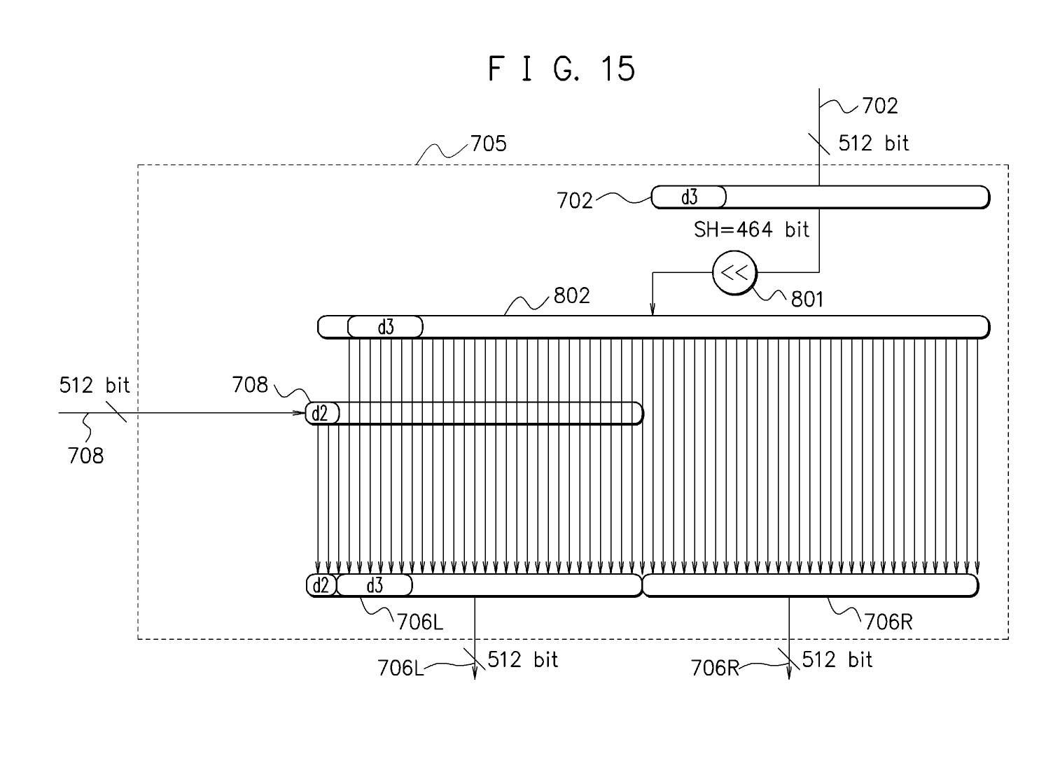

Next, an operation of the shift selection circuit 705 will be described while referring to FIG. 15. FIG. 15 is a diagram illustrating an example of processing of the shift selection circuit 705 in FIG. 8 in the third cycle. In the third cycle, the shift circuit 801 shifts the 512-bit data 702 in the left direction by the shift amount SH (=464 bits), and outputs the 2×512-bit data 802.

In FIG. 8, the n-th selector SELn selects the data 802 when the following equation is satisfied, selects the data 708 when the following equation is not satisfied, and outputs the selected data. Here, BS indicates a current valid data length of the buffer 704 in FIG. 14, and the valid data length BS is 48 bits.

n>BS/16

n>48/16

n>3

In FIG. 15, the selectors SEL1 to SEL3 select the data 708, the selectors SEL4 to SEL32 select the data 802, and the 512-bit data 706L is output. As a result of this, the first-half 512-bit data 706L has the 48-bit valid data d2 and the 112-bit valid data d3. Further, the latter-half 512-bit data 706R is the same as latter-half 512-bit data of the 2×512-bit data 802.

Next, in FIG. 14, since the control signal MF is “0”, the gate circuit 707 does not output the 512-bit data 706L and the write request signal PD. Further, since the control signal MF is “0”, the selector 703 selects the data 706L, resulting in that the 512-bit data 706L in FIG. 14 is written into the buffer 704, as illustrated in FIG. 16.

FIG. 16 is a diagram illustrating an example of processing of the data processing circuit 104 in FIG. 7 in a fourth cycle. In the fourth to sixth cycles, the data DA1 in FIG. 9B for the second time is processed. In the fourth cycle, data of the first memory line in FIG. 9B is input as the 512-bit data 702. The 512-bit data 702 has valid data d4, the valid data offset FS of 464 bits, and the valid data length SZ of 48 bits. The 48-bit valid data d4 corresponds to the 48-bit valid data d1 in FIG. 9B.

Further, the calculation part 701 calculates the shift amount SH through the following equation.

$$\begin{matrix}SH = FS - BS + 512 \\ = 464 - 160 + 512 \\ = 816 bits\end{matrix}$$

Further, the calculation part 701 calculates the valid data length BSt in the next cycle through the following equation.

$$\begin{matrix}BSt = SZ + BS \\ = 48 + 160 \\ = 208 bits\end{matrix}$$

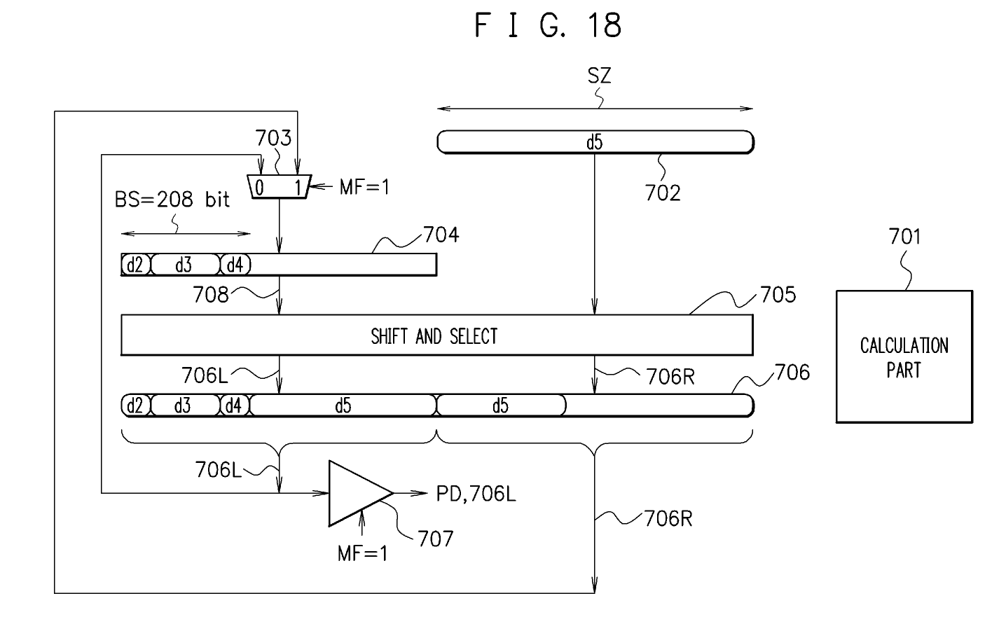

Since the valid data length BSt in the next cycle is less than 512 bits, the calculation part 701 sets the valid data length BS of the buffer 704 in the next cycle (FIG. 18) through the following equation.

$$\begin{matrix}BS = BSt \\ = 208 bits\end{matrix}$$

Further, since the valid data length BSt in the next cycle is less than 512 bits, the calculation part 701 sets the control signal MF to “0”.

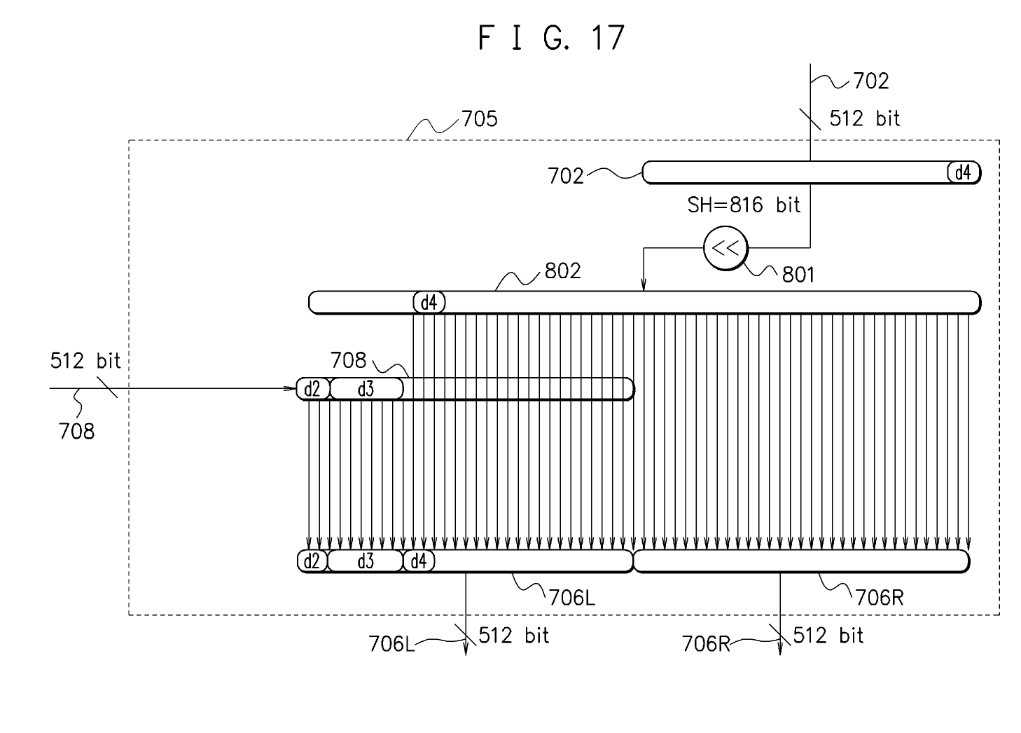

Next, an operation of the shift selection circuit 705 will be described while referring to FIG. 17. FIG. 17 is a diagram illustrating an example of processing of the shift selection circuit 705 in FIG. 8 in the fourth cycle. In the fourth cycle, the shift circuit 801 shifts the 512-bit data 702 in the left direction by the shift amount SH (=816 bits), and outputs the 2×512-bit data 802.

In FIG. 8, the n-th selector SELn selects the data 802 when the following equation is satisfied, selects the data 708 when the following equation is not satisfied, and outputs the selected data. Here, BS indicates a current valid data length of the buffer 704 in FIG. 16, and the valid data length BS is 160 bits.

n>BS/16

n>160/16

n>10

In FIG. 17, the selectors SEL1 to SEL10 select the data 708, the selectors SEL11 to SEL32 select the data 802, and the 512-bit data 706L is output. As a result of this, the first-half 512-bit data 706L has the 48-bit valid data d2, the 112-bit valid data d3 and the 48-bit valid data d4. Further, the latter-half 512-bit data 706R is the same as latter-half 512-bit data of the 2×512-bit data 802.

Next, in FIG. 16, since the control signal MF is “0”, the gate circuit 707 does not output the 512-bit data 706L and the write request signal PD. Further, since the control signal MF is “0”, the selector 703 selects the data 706L, resulting in that the 512-bit data 706L in FIG. 16 is written into the buffer 704, as illustrated in FIG. 18.

FIG. 18 is a diagram illustrating an example of processing of the data processing circuit 104 in FIG. 7 in a fifth cycle. In the fifth cycle, data of the second memory line in FIG. 9B is input as the 512-bit data 702. The 512-bit data 702 has valid data d5, the valid data offset FS of 0 bit, and the valid data length SZ of 512 bits. The 512-bit valid data d5 corresponds to the 512-bit valid data d2 in FIG. 9B.

Further, the calculation part 701 calculates the shift amount SH through the following equation.

$$\begin{matrix}SH = FS - BS + 512 \\ = 0 - 208 + 512 \\ = 304 bits\end{matrix}$$

Further, the calculation part 701 calculates the valid data length BSt in the next cycle through the following equation.

$$\begin{matrix}BSt = SZ + BS \\ = 512 + 208 \\ = 720 bits\end{matrix}$$

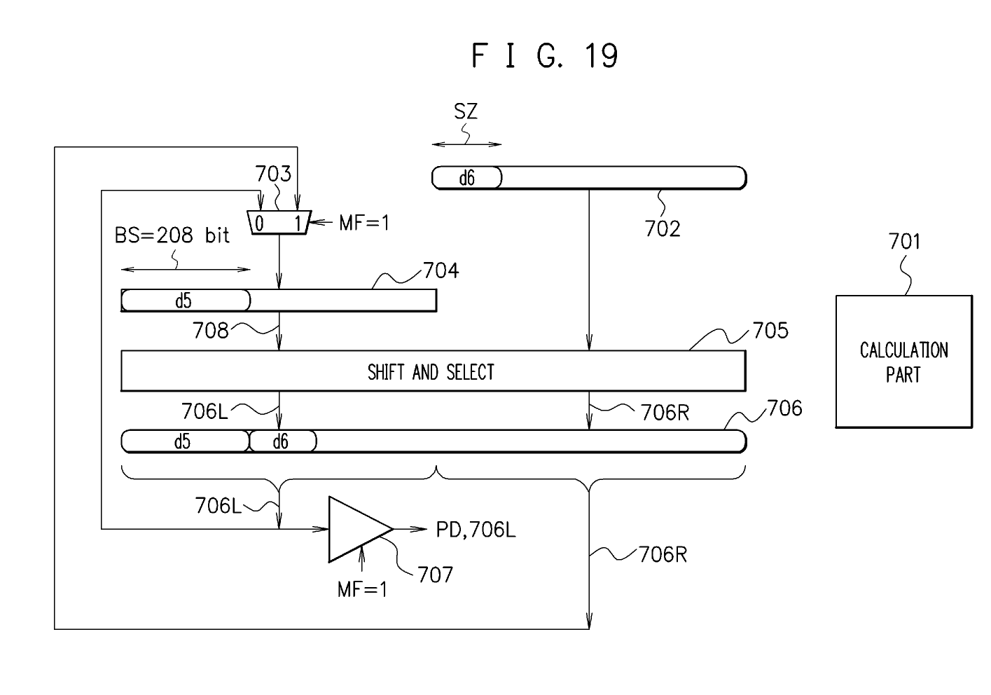

Since the valid data length BSt in the next cycle is 512 bits or more, the calculation part 701 sets the valid data length BS of the buffer 704 in the next cycle (FIG. 19) through the following equation.

$$\begin{matrix}BS = BSt - 512 \\ = 720 - 512 \\ = 208 bits\end{matrix}$$

Further, since the valid data length BSt in the next cycle is 512 bits or more, the calculation part 701 sets the control signal MF to “1”.

Next, an example of processing of the shift selection circuit 705 in FIG. 8 in the fifth cycle will be described. In the fifth cycle, the shift circuit 801 shifts the 512-bit data 702 in the left direction by the shift amount SH (=304 bits), and outputs the 2×512-bit data 802.

The n-th selector SELn selects the data 802 when the following equation is satisfied, selects the data 708 when the following equation is not satisfied, and outputs the selected data. Here, BS indicates a current valid data length of the buffer 704 in FIG. 18, and the valid data length BS is 208 bits.

n>BS/16

n>208/16

n>13

The selectors SEL1 to SEL13 select the data 708, the selectors SEL14 to SEL32 select the data 802, and the 512-bit data 706L is output. As a result of this, the first-half 512-bit data 706L has the 48-bit valid data d2, the 112-bit valid data d3, the 48-bit valid data d4 and the 304-bit valid data d5. Further, the latter-half 512-bit data 706R has the 208-bit valid data d5 at the final portion.

Next, since the control signal MF is “1”, the gate circuit 707 outputs the 512-bit data 706L and the write request signal PD to the first-in-first-out circuits 105A to 105D in FIG. 1 corresponding to the write request signal PD. Further, since the control signal MF is “1”, the selector 703 selects the data 706R, resulting in that the 512-bit data 706R in FIG. 18 is written into the buffer 704, as illustrated in FIG. 19.

FIG. 19 is a diagram illustrating an example of processing of the data processing circuit 104 in FIG. 7 in a sixth cycle. In the sixth cycle, data of the third memory line in FIG. 9B is input as the 512-bit data 702. The 512-bit data 702 has valid data d6, the valid data offset FS of 0 bit, and the valid data length SZ of 112 bits. The 112-bit valid data d6 corresponds to the 112-bit valid data d3 in FIG. 9B.

Further, the calculation part 701 calculates the shift amount SH through the following equation.

$$\begin{matrix}SH = FS - BS + 512 \\ = 0 - 208 + 512 \\ = 304 bits\end{matrix}$$

Further, the calculation part 701 calculates the valid data length BSt in the next cycle through the following equation.

$$\begin{matrix}BSt = SZ + BS \\ = 112 + 208 \\ = 320 bits\end{matrix}$$

Since the valid data length BSt in the next cycle is less than 512 bits, the calculation part 701 sets the valid data length BS of the buffer 704 in the next cycle through the following equation.

$$\begin{matrix}BS = BSt \\ = 320 bits\end{matrix}$$

Further, at the time of final cycle, the calculation part 701 sets the control signal MF to “1”.

Next, an example of processing of the shift selection circuit 705 in FIG. 8 in the sixth cycle will be described. In the sixth cycle, the shift circuit 801 shifts the 512-bit data 702 in the left direction by the shift amount SH (=304 bits), and outputs the 2×512-bit data 802.

The n-th selector SELn selects the data 802 when the following equation is satisfied, selects the data 708 when the following equation is not satisfied, and outputs the selected data. Here, BS indicates a current valid data length of the buffer 704 in FIG. 19, and the valid data length BS is 208 bits.

n>BS/16

n>208/16

n>13

The selectors SEL1 to SEL13 select the data 708, the selectors SEL14 to SEL32 select the data 802, and the 512-bit data 706L is output. As a result of this, the first-half 512-bit data 706L has the 208-bit valid data d5 and the 112-bit valid data d6. Further, the latter-half 512-bit data 706R is the same as latter-half 512-bit data of the 2×512-bit data 802.

Next, since the control signal MF is “1”, the gate circuit 707 outputs the 512-bit data 706L and the write request signal PD to the first-in-first-out circuits 105A to 105D in FIG. 1 corresponding to the write request signal PD.

As described above, when the data DA1 in FIG. 9B is continuously read twice from the memory 102, the data processing circuit 104 can delete the invalid data 401, and output the data as a result of combining the pieces of valid data d1 to d6.

Concretely, the shift circuit 801 makes the data 702 with the certain bit length to be input therein for each cycle, shifts the data 702 to delete the first invalid data 401 in the data 702, and outputs the data 802. The gate circuit 707 cuts, when the data 706 as a result of combining pieces of the shifted data for each cycle has the certain bit length or more, the first data 706L with the certain bit length to output the data 706L to the outside. The calculation unit 106 performs the calculation using the data 706L output by the gate circuit 707.

When the data 706 as a result of combining the pieces of data of the continuous plurality of cycles shifted by the shift circuit 801 has a bit length which is less than the certain bit length, the buffer 704 buffers the first data 706L with the certain bit length. Further, when the data 706 as a result of combining the pieces of data of the continuous plurality of cycles shifted by the shift circuit 801 has a bit length which is equal to or more than the certain bit length, the buffer 704 buffers the remaining data 706R as a result of removing the first data 706L with the certain bit length.

The selectors SEL1 to SEL32 select the valid data in the data 708 of the buffer 704. The gate circuit 707 cuts, when the data 706 as a result of combining the valid data in the previous cycle selected by the selectors SEL1 to SEL32 and the valid data in the current cycle shifted by the shift circuit 801 has the certain bit length or more, the first data 706L with the certain bit length to output the data 706L to the outside.

The memory 102 reads the data 702 with the certain bit length for each cycle and outputs the data 702 to the shift circuit 801. The first-in-first-out circuits 105A to 105D are provided between the gate circuit 707 and the calculation unit 106.

As described above, the data processing device can generate the stream of valid data by deleting the invalid data in the data 702 with the certain bit length. Accordingly, it is possible to eliminate the loss caused by the waiting time in the calculation using the data. Further, by using the shift circuit 801 and the buffer 704, it is possible to reduce the circuit scale.

It is possible to generate a stream of valid data by deleting invalid data in data with a certain bit length. Accordingly, it is possible to eliminate a loss caused by a waiting time in a calculation using the data.

Note that the above-described embodiments merely illustrate concrete examples of implementing the present embodiments, and the technical scope of the present embodiments is not to be construed in a restrictive manner by these embodiments. That is, the present embodiments may be implemented in various forms without departing from the technical spirit or main features thereof.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A data processing device, comprising:
a shift circuit that makes data with a certain bit length to be input therein for each cycle, and shifts the data to delete first invalid data in the data; and
a gate circuit that cuts, when data as a result of combining pieces of the shifted data for each cycle has the certain bit length or more, first data with the certain bit length to output the data to an outside.

2. The data processing device according to claim 1, further comprising
a calculation unit that performs calculation by using the data output by the gate circuit.

3. The data processing device according to claim 1, further comprising
a buffer that buffers, when data as a result of combining pieces of the shifted data of continuous plurality of cycles has a bit length which is less than the certain bit length, first data with the certain bit length, and buffers, when the data as a result of combining the pieces of the shifted data of the continuous plurality of cycles has a bit length which is equal to or more than the certain bit length, remaining data as a result of removing the first data with the certain bit length.

4. The data processing device according to claim 3, further comprising
selectors that select valid data in the data of the buffer, wherein
the gate circuit cuts, when data as a result of combining valid data in a previous cycle selected by the selectors and valid data in a current cycle shifted by the shift circuit has the certain bit length or more, first data with the certain bit length to output the data to the outside.

5. The data processing device according to claim 1, further comprising
a memory that reads the data with the certain bit length for each cycle and outputs the data to the shift circuit.

6. The data processing device according to claim 2, further comprising
first-in-first-out circuits that are provided between the gate circuit and the calculation unit.
